(19) United States
(12) Patent Application Publication
(10) Pub. No.: US 2008/0273503 A1
(43) Pub. Date: Nov. 6, 2008

(54) METHOD AND TERMINAL FOR PERFORMING HANDOVER IN MOBILE COMMUNICATIONS SYSTEM OF POINT-TO-MULTIPOINT SERVICE

(75) Inventors: Young-Dae Lee, Gyeonggi-Do (KR); Sung-Duck Chun, Gyeonggi-Do (KR); Sung-Jun Park, Gyeonggi-Do (KR); Seung-June Yi, Gyeonggi-Do (KR)

Correspondence Address: LEE, HONG, DEGERMAN, KANG & SCHMADEKA, 660 S. FIGUEROA STREET, Suite 2300, LOS ANGELES, CA, 90017, US

(73) Assignee: LG Electronics Inc.

(21) Appl. No.: 12/113,816

(22) Filed: May 1, 2008

Related U.S. Application Data
(60) Provisional application No. 60/915,666, filed on May 2, 2007.

(30) Foreign Application Priority Data
Apr. 18, 2008 (KR) 10-2008-0036212

(51) Int. Cl. H04Q 7/20; H04J 3/06

(52) U.S. Cl. 370/336; 370/331

(57) ABSTRACT

A method for performing a handover in a mobile communications system of a Multimedia Broadcast/Multicast Service (MBMS), wherein when a terminal having subscribed (joined) a point-to-multipoint service moves from a first base station to a second base station, the terminal is commanded (indicated) by the first base station to transfer point-to-multipoint service information, and then transfers to the second base station a point-to-multipoint service list subscribed (joined) by the terminal or information on the point-to-multipoint service received from the first base station, whereby a service delay which may occur during the handover can be effectively avoided.

### CROSS REFERENCE TO RELATED APPLICATIONS

Pursuant to 35 U.S.C. §119, the present application claims the benefit of earlier filing date and right of priority to Provisional Application No. 60/915,666, filed May 2, 2007, and Korean application number 10-2008-0036212, filed Apr. 18, 2008, the contents of which are hereby incorporated by reference herein in their entirety.

### BACKGROUND OF THE INVENTION

1. Field of the Invention

The present invention relates to a point-to-multipoint service, and particularly, to a method for performing a handover in a mobile communications system of a point-to-multipoint service, wherein the point-to-multipoint service (e.g., a Multimedia Broadcast/Multicast Service (MBMS)) is one in which data is transmitted (provided) from a single source entity to multiple receivers (recipients).

2. Background of the Invention

FIG. 1 shows a network structure of an Evolved Universal Terrestrial Radio Access Network (E-UTRAN), which is a mobile communications system to which the related art and the present invention are all applied. The E-UTRAN system has evolved from the existent UTRAN system and a basic standardization therefor is undergoing in 3GPP. Such E-UTRAN system is also referred to as a Long Term Evolution (LTE) system.

The E-UTRAN comprises base stations (hereinafter, abbreviated as eNode Bs or eNBs), which are connected to each other via an X2 interface. Each eNB is connected to a terminal (User Equipment; UE) via a radio interface, and connected to an Evolved Packet Core (EPC) via a S1 interface.

Radio interface protocol layers between the terminal and the network can be divided into a first layer (L1), a second layer (L2) and a third layer (L3) based on three lower layers of an Open System Interconnection (OSI) standard model widely known in communications systems. A physical layer belonging to the first layer provides an information transfer service using a physical channel. A Radio Resource Control (RRC) layer located at the lowest portion of the third layer controls radio resources between the terminal and the network. For this purpose, the RRC layer allows RRC messages to be exchanged between the terminal and the network.

FIGS. 2 and 3 show a radio interface protocol architecture between a terminal and E-UTRAN based on 3GPP radio access network standards. Particularly, FIG. 2 shows a radio protocol architecture in a control plane, and FIG. 3 shows a radio protocol architecture in a user plane.

The radio interface protocol in FIGS. 2 and 3 has horizontal layers comprising a physical layer, a data link layer and a network layer, and has vertical planes comprising a user plane for transmitting user traffic and a control plane for transmitting control signals. The protocol layers in FIGS. 2 and 3 can be divided into a first layer (L1), a second layer (L2) and a third layer (L3) based on three lower layers of an Open System Interconnection (OSI) standard model widely known in communications systems. Hereinafter, each layer in the radio protocol control plane in FIG. 2 and a radio protocol user plane in FIG. 3 will be described.

A first layer, as a physical layer, provides an information transfer service to an upper layer using a physical channel. The physical layer is connected to its upper layer, called a Medium Access Control (MAC) layer, via a transport channel. The MAC layer and the physical layer exchange data via the transport channel. Data is transferred via a physical channel between different physical layers, namely, between the physical layer of a transmitting side and the physical layer of a receiving side. The physical channel is modulated based on an Orthogonal Frequency Division Multiplexing (OFDM) technique, and utilizes time and frequency as radio resources.

The MAC layer located at the second layer provides a service to an upper layer, called a Radio Link Control (RLC) layer, via a logical channel. The RLC layer of the second layer supports reliable data transmissions. The function of the RLC layer may be implemented as a functional block in the MAC layer. In this case, the RLC layer may not exist. A Packet Data Convergence Protocol (PDCP) layer of the second layer, in the radio protocol user plane, is used to efficiently transmit IP packets, such as IPv4 or IPv6, on a radio interface with a relatively narrow bandwidth. For this purpose, the PDCP layer reduces the size of an IP packet header which is relatively great in size and includes unnecessary control information, namely, a function called header compression is performed.

A Radio Resource Control (RRC) layer located at the lowest portion of the third layer is only defined in the control plane. The RRC layer controls logical channels, transport channels and physical channels in relation to establishment, re-configuration and release of Radio Bearers (RBs). Here, the RB signifies a service provided by the second layer for data transmissions between the terminal and the E-UTRAN. If an RRC connection is established between the RRC layer of the terminal and the RRC layer of the radio network, the terminal is in the RRC connected mode. Otherwise, the terminal is in an RRC idle mode.

A Non-Access Stratum (NAS) layer located at an upper portion of the RRC layer performs functions, such as session management, mobility management and the like.

One cell constructing an eNB is set to one of bandwidths of 1.25 MHz, 2.5 MHz, 5 MHz, 10 MHz, 20 MHz and the like, so as to provide downlink or uplink transmission services to multiple terminals. Here, different cells may be set to provide different bandwidths.

Downlink transport channels for transmitting data from a network to a terminal may comprise a Broadcast Channel (BCH) for transmitting system information, a Paging Channel (PCH) for transmitting paging messages and a downlink Shared Channel (SCH) for transmitting other user traffic or control messages. Traffic or control messages of a downlink point-to-multipoint service (multicast or broadcast service) may be transmitted either via a downlink SCH, or via a separate downlink Multicast Channel (MCH). In addition, uplink transport channels for transmitting data from a terminal to a network may comprise a Random Access Channel (RACH) for transmitting an initial control message and an uplink Shared Channel (SCH) for transmitting user traffic or control messages.

Logical channels which are located at an upper portion of transport channels and mapped to the transport channels include a Broadcast Control Channel (BCCH), a Paging Control Channel (PCCH), a Common Control Channel (CCCH), a MBMS point-to-multipoint Control Channel/Multicast Control Channel (MCCH), a MBMS point-to-multipoint Traffic Channel/Multicast Traffic Channel (MTCH), and the like.

FIG. 4 shows a transmission on a control channel according to the related art.

A physical channel is composed of multiple sub-frames arranged on a time axis and multiple sub-carriers arranged on a frequency axis. Here, a single sub-frame includes a plurality of symbols on the time axis. One sub-frame is composed of a plurality of resource blocks, each of which includes a plurality of symbols and a plurality of sub-carriers. Also, each sub-frame can use particular sub-carriers of particular symbols (e.g., a first symbol) at the corresponding sub-frame for a Physical Downlink Control Channel (PDCCH), namely, a L1/L2 control channel. One sub-frame is a time duration of 0.5 ms. A Transmission Time Interval (TTI) as a unit time for which data is transmitted is 1 ms corresponding to two sub-frames.

A radio network may recognize an existence of terminals which are receiving a particular (specific) point-to-multipoint service in a specific cell, or perform a counting process upon desiring to count the number of terminals. Such point-to-multipoint counting process denotes a process in which, when a radio network transmits an access information message via a MCCH channel, a terminal transmits an RRC connection request message or cell update message in response to the access information message.

### SUMMARY OF THE INVENTION

The present invention is directed to a radio (mobile) terminal which receives a point-to-multipoint service, and in particular, a method for performing a handover in which, when a terminal having subscribed (or been interested in) a point-to-multipoint service moves from a first base station (i.e., source base station; source eNB) to a second base station (i.e., a target base station; target eNB), the terminal is commanded (indicated) by the first base station to transfer point-to-multipoint service information, and then transfers, to the second base station, a point-to-multipoint service list (i.e., point-to-multipoint activated service list) which the terminal has subscribed (or been interested in) or information related to a point-to-multipoint service (e.g., point-to-multipoint selected service list) received from the first base station, according to the command (indication) of the first base station.

Also, the present invention relates to a method for performing a handover in which when a terminal having subscribed (or been interested in) a point-to-multipoint service moves from a first base station to a second base station and then receives a handover command from the first base station, the terminal is commanded (indicated) by the first base station to transfer to the second base station point-to-multipoint service information, and then transfers, to the second base station, a point-to-multipoint service list which the terminal has subscribed (or been interested in) and/or information on a point-to-multipoint service received from the first base station and other point-to-multipoint service related information.

In the related art, information related to a service that the terminal wanted to receive was managed by a base station controller positioned at an upper portion of a base station. Hence, upon performing a handover which a terminal moves to another base station, the base station performed a control function of a point-to-multipoint service with respect to the corresponding terminal according to the information from the base station controller. In this case, since the base station should always perform the point-to-multipoint service control function via the base station controller, time delay for the point-to-multipoint service may occur upon performing the handover.

Therefore, an object of the present invention is to exclude the point-to-multipoint service control function by the base station controller in the related art, but rather allow base stations (eNBs) between which a handover of a terminal is performed to transmit and/or receive information on a point-to-multipoint service the terminal has subscribed (or been interested in), so as to prevent a service delay of the point-to-multipoint service provided to the terminal upon the handover.

To achieve these and other advantages and in accordance with the purpose of the present invention, as embodied and broadly described herein, there is provided a method for performing a handover of a terminal from a first base station to second base station when the terminal to which the first base station provides a point-to-multipoint service moves to the second base station, the method comprising: deciding a handover, by the first base station, and transmitting a handover request message including first information related to a point-to-multipoint service to the second base station; receiving, by the first base station, a response message from the second base station; and commanding (indicating), by the first base station, the terminal to transfer the first information to the second base station via a handover command message, when the first base station does not receive second information related to the point-to-multipoint service from the second base station via the response message.

Preferably, the method may further comprise: synchronizing, by the terminal, a downlink channel with the second base station; transmitting, by the terminal, a random access preamble to the second base station; receiving a random access response in the terminal; and transmitting, by the terminal, a handover confirm message to the second base station.

Preferably, the first information related to the point-to-multipoint service comprises at least one of point-to-multipoint service information which the first base station provides, and point-to-multipoint service information related to the terminal.

Preferably, the point-to-multipoint service information related to the terminal may include a point-to-multipoint service list which the terminal has subscribed (or been interested in) and a point-to-multipoint service list which the terminal is currently receiving.

Preferably, the point-to-multipoint service information provided by the first base station may be control information of the first base station with respect to a point-to-multipoint service which the terminal has subscribed (or been interested in) and/or a point-to-multipoint service which the terminal is currently receiving.

Preferably, the second information related to the point-to-multipoint service may include control information of the second base station with respect to the point-to-multipoint service which the terminal has subscribed (or been interested in) and/or the point-to-multipoint service which the terminal is currently receiving.

Preferably, the control information of the second base station may include a random access preamble signature for the point-to-multipoint service used in the second base station.

In another embodiment of the present invention, there is provided a method for performing a handover in a mobile communications system, as a method in which a handover of a terminal is performed from a first base station to a second base station, the method comprising: receiving, by the first base station, from the second base station a response message to a handover requested to the second base station; and transmitting, by the first base station, a handover command message to the terminal, so as to command (indicate) the terminal to transfer point-to-multipoint service related information toward the second base station.

In another embodiment of the present invention, there is provided a terminal comprising: a transmitting/receiving unit including a receiving unit adapted to receive a handover command message from a source base station, and a transmitting unit adapted to transmit point-to-multipoint service information included in the handover command message to a target base station according to an indication to transfer the point-to-multipoint service information; and a processor adapted to process the point-to-multipoint service information to be transmitted to the target base station when the indication to transfer the point-to-multipoint service information is included in the handover command message.

In another embodiment of the present invention, there is provided a method for performing a handover in a mobile communications system, as a method in which a handover of a terminal is performed from a first base station to a second base station when the terminal is currently receiving a point-to-multipoint service from the first base station moves to the second base station, the method comprising: making, by the first base station, a handover decision and then transmitting a handover request message including first information related to the point-to-multipoint service to the second base station; receiving, by the first base station, a response message from the second base station, the response message including second information related to the point-to-multipoint service; and transmitting, by the first base station, to the terminal a handover command together with the second information.

Also, in another aspect of the present invention, in order to avoid a service delay which may occur during a handover, in case where a terminal having subscribed (or been interested in) a point-to-multipoint service moves from a first base station to a second base station, the first base station transfers information related to the point-to-multipoint service the terminal has subscribed to the second base station, and the second base station then notifies the terminal of the handover completion after receiving the information related to the point-to-multipoint service, whereby the point-to-multipoint service is provided to the terminal according to the received information.

In addition, in case where a terminal having subscribed (or been interested in) a point-to-multipoint service moves from a first base station to a second base station, the terminal is commanded (indicated) by the first base station to transfer the point-to-multipoint service, and accordingly transfers to the second base station a point-to-multipoint service list the terminal has subscribed or point-to-multipoint service related information received from the first base station according to the indication.

Preferably, after performing the handover to the second base station, the terminal may transfer the point-to-multipoint service received from the first base station and transmission/control information related to a downlink channel provided from the first base station for the point-to-multipoint service.

Preferably, the information may be transferred by being included in the message for the first base station to request a handover from the second base station.

Preferably, the second base station may include the control information on the point-to-multipoint service in a response message with respect to the handover request message and transmit the response message to the first base station.

Preferably, the control information related to the point-to-multipoint service may include configuration/transmission information on MCCH channel provided from a cell in the second base station and channel information related to the service.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 shows a network structure of an Evolved Universal Terrestrial Radio Access Network (E-UTRAN) as a mobile communications system to which both the related art and the present invention are applied;

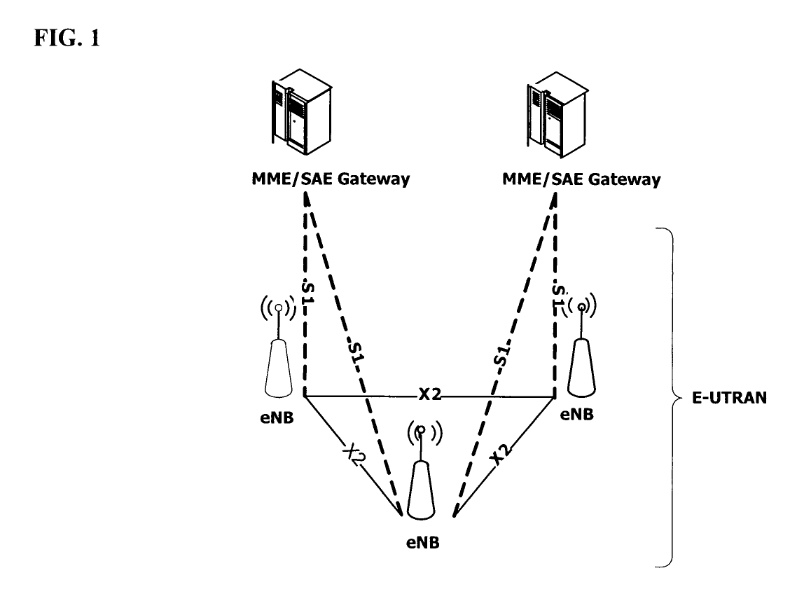

FIG. 2 shows a radio interface protocol architecture in a control plane between a terminal and a Evolved UMTS Terrestrial Radio Access Network (E-UTRAN) based on 3GPP radio access network standards;

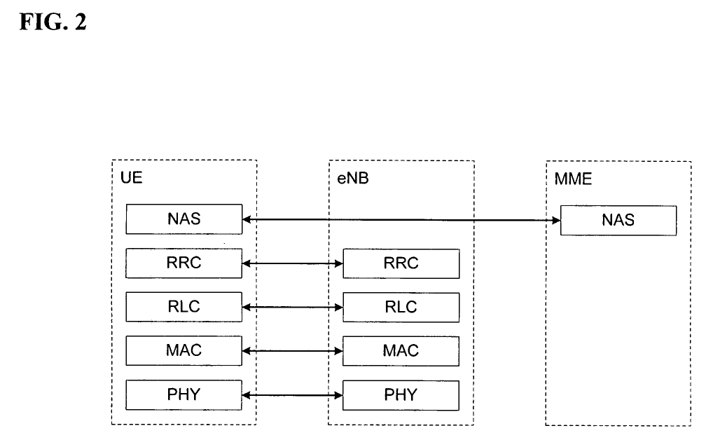

FIG. 3 shows a radio interface protocol architecture in a user plane between a terminal and a Evolved UMTS Terrestrial Radio Access Network (E-UTRAN) based on 3GPP radio access network standards;

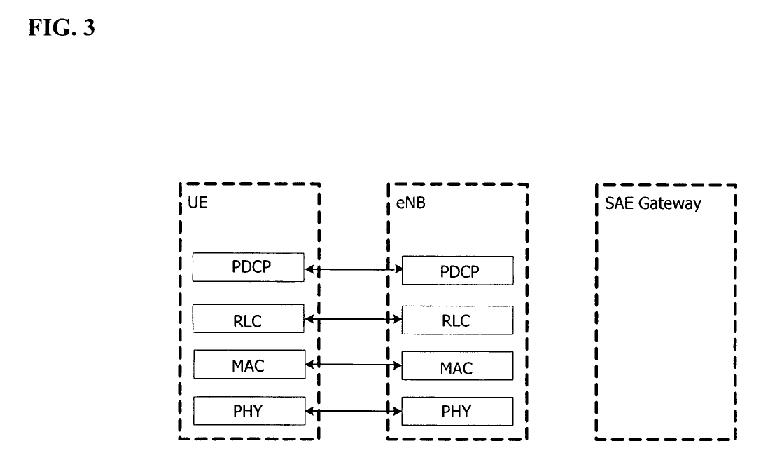

FIG. 4 shows a transmission on a control channel according to the related art;

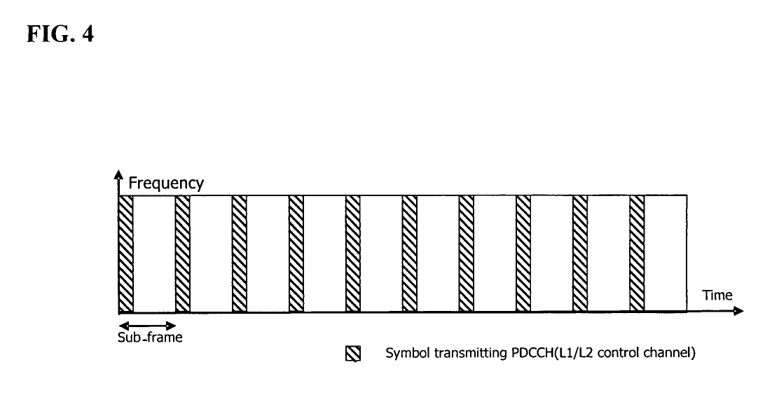

FIG. 5 is a signal flowchart showing a handover process of a terminal receiving a MBMS service according to the present invention; and

FIG. 6 is a block diagram schematically showing a terminal according to the present invention.

### DETAILED DESCRIPTION OF THE INVENTION

The present invention is applied to a point-to-multipoint service system in radio communications. However, the present invention is not limited to this but rather applicable to all systems and methods to which the technical features of the present invention can be applied.

The present invention conceptually relates to substituting a control function of a base station controller (BSC) causing a Multimedia Broadcast and Multicast Service (MBMS) service delay in the related art by allowing transmission and reception of control information on a MBMS service and MBMS service information among a terminal and base stations (i.e., a source base station and a target base station) between which the terminal performs a handover, in order to solve the MBMS service delay caused due to the BSC performing the control function, when the terminal performs the handover from the source base station to the target base station in the MBMS service. That is, in the present invention, first, a first base station transmits MBMS service information subscribed (or been interested in) by a terminal (e.g., a MBMS activated service list) and/or MBMS service information currently received by the terminal (e.g., a MBMS selected service list) to a second base station to which the terminal performs a handover, or the terminal transfers MBMS service information subscribed by the terminal and/or MBMS service related information currently received from the first base station to the second base station, under an indication (command, or notification) of the first base station. Second, in the present invention, the second base station provides the MBMS service to the terminal based upon information of MBMS service subscribed by the terminal and/or information of MBMS service currently received by the terminal, when the terminal performs the handover from the first base station to the second base station.

Meanwhile, among terms described in the present invention, “MBMS activated services” in information of the MBMS service subscribed by the terminal (e.g., the MBMS activated service list) indicates the MBMS multicast services the UE (or terminal) has subscribed as well as broadcast services the UE is interested in. Also, “MBMS selected services” in the MBMS service information (e.g., the MBMS selected services list) indicates a subset of the MBMS activated services of (the broadcast type) for which the UE applies RRC procedures to inform UTRAN that the services have been selected (by upper layers).

Hereinafter, the preferred embodiments of the present invention will be described with reference to the accompanying drawings.

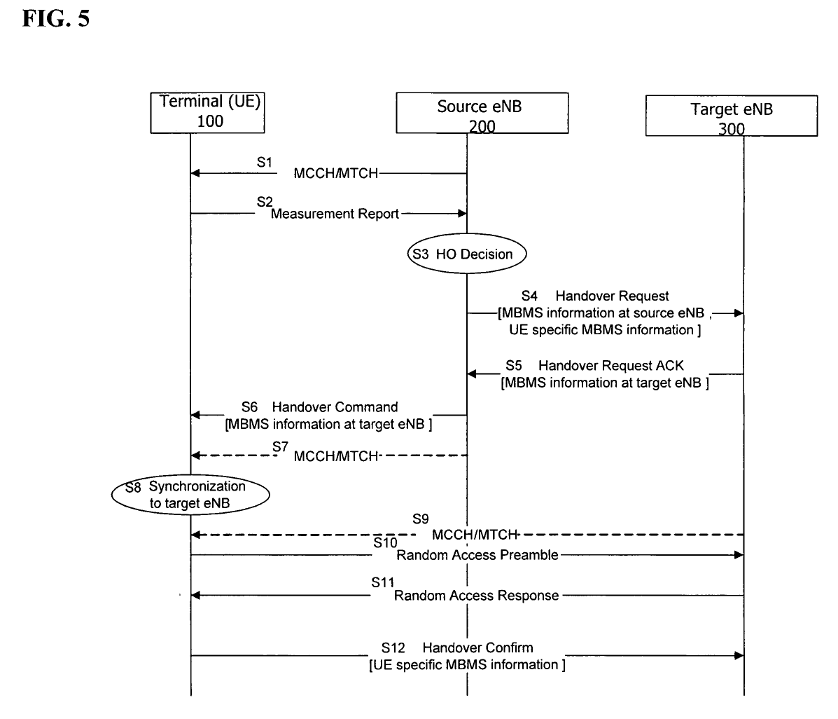

FIG. 5 is a signal flowchart showing a handover process by a UE receiving a MBMS service according to the present invention.

As shown in FIG. 5, a terminal (User Equipment; UE) 100 reads a MCCH channel and a MTCH channel for a specific service (i.e., a specific MBMS service) from a source base station (source eNB) 200 (S1). The MCCH channel is to transmit control information related to the specific MBMS service, while the MTCH channel is to transmit data for the specific MBMS service.

The terminal 100 is moving from a current eNB (i.e., the source eNB) to another base station (i.e., a target base station (target eNB)). The terminal 100 which is currently moving sends a measurement report, as information for a handover decision, to the source eNB 200 (S2). The source eNB 200 then decides the handover of the terminal 100 based on the measurement report (i.e. “HO (Handover) decision” in FIG. 5) (S3).

The source eNB 200 requests the handover of the terminal 100 from a target eNB 300 (i.e., “handover request” in FIG. 5) (S4). Here, the source eNB 200 transfers MBMS service information it provides (referred to as ‘Information A’ for convenience) and MBMS service information related to the terminal 100 (referred to as ‘Information B’ for convenience) to the target eNB 300. Here, the terminal related MBMS service information (i.e., Information B) may include, for example, a MBMS service list which the terminal 100 has subscribed (i.e., a MBMS activated service list) and a point-to-multipoint service list which the terminal 100 is currently receiving (i.e., a MBMS selected service list). Also, the MBMS service information (i.e., Information A) provided from the source eNB 200 may include control information of the source eNB 200 related to services subscribed by the terminal 100 or services currently received by the terminal 100 (e.g., the control information includes a MTCH transmission rate, a MCCH transmission period, MTCH scheduling information, HARQ information including the number of retransmissions, and the like).

The target eNB 300 transmits to the source eNB 200 a response (“handover request Ack” in FIG. 5) to the handover request for the terminal 100 (S5). Here, the response message (i.e., handover request Ack) may include control information (referred to as ‘information C’ for convenience) of the target eNB 300 related to services subscribed by the terminal 100 or services currently received by the terminal 100. Such control information (i.e., Information C) of the target eNB 300 may include, for example, MCCH configuration information, MCCH transmission period, MTCH configuration information, MTCH scheduling information, HARQ information of MTCH, information on an uplink feedback channel for MBMS, and the like. The control information (i.e., Information C) may also include a random access preamble signature for the specific service used in the target eNB 300. In the meantime, the control information (i.e., Information A) of the source eNB 200 and the control information (i.e., Information C) of the target eNB 300 are different from each other in subjects.

The source eNB 200 transmits a handover command message (i.e., “handover command”) to the terminal 100 so as to indicate a handover toward the target eNB 300 (S6). Here, the handover command message may include the control information (i.e., Information C) transferred from the target eNB 300 for the services subscribed by the terminal 100 and/or services currently received by the terminal 100. The handover command message may also include the random access preamble signature for the specific service (i.e., the specific MBMS service) transferred from the target eNB 300.

In another embodiment of the present invention, at the step S5, if the target eNB 300 does not transfer the control information (i.e. Information C) to the source eNB 200 (or if the source eNB 200 does not receive the control information (i.e. information C) from the target eNB 300), the source eNB 200, at the step S6, commands (indicates) the terminal 100 via the handover command message to transmit the terminal related MBMS service information (i.e., Information B) to the target eNB 300. Also, the source eNB 200 may transfer the MBMS service information (i.e., Information A), which it provides, to the terminal 100 via the handover command message. In addition, the source eNB 200 may command (indicate) the terminal 100 to transfer such information (i.e., Information A) to the target eNB 300. That is, the terminal 100 according to the present invention may receive from the source eNB 200 an indication (command) included in the handover command message (i.e., the indication that terminal related MBMS service information (i.e., Information B) and/or information of the source eNB 200 (i.e., Information A) should be transmitted to the target eNB 300), and then directly transmit at least one of the Information A and the Information B to the target eNB 300 to which the handover is to be performed. Hence, upon the handover, the source eNB 200 does not have to transmit point-to-multipoint service information (e.g., Information A and/or Information B) to the target eNB 300, whereby resources required for the transmission of the point-to-multipoint service information between the source eNB 200 and the target eNB 300 upon the handover can be reduced, resulting in an increase in resource efficiency.

The terminal 100 can continuously read the MCCH channel and the MTCH channel for the specific service from the source eNB 200 until before moving to the target eNB 300 (S7).

After receiving the handover command message at the step S6, then the terminal 100 performs the handover. That is, the terminal 100 moves to the target eNB 300 to try to synchronize a downlink channel (S8). After the synchronization of the downlink channel, then the terminal 100 can read the MCCH channel and the MTCH channel for the specific service from the target eNB 300 (S9). That is, the terminal 100 is allowed to receive the specific service, which it has been being received from the source eNB 200 just before the handover, from the target eNB 300.

The terminal 100 then uses the random access preamble signature included in the handover command message to transmit a random access preamble to the target eNB 300 (S10). The target eNB 300 then responds to the random access preamble (i.e., “Random Access Response” in FIG. 5) (S11).

Accordingly, the terminal 100 transmits a handover confirm message (Handover Confirm) to the target eNB 300 (S12).

In another embodiment of the present invention, on the other hand, if the handover command message of the step S6 has included a transmission indication (command) of the terminal related MBMS service information toward the target eNB 200, the terminal 100 includes the terminal related MBMS service information (i.e., Information B) in the handover confirm message and then transmits the handover confirm message. Here, the terminal related MBMS service information (i.e., Information B), as similar to the information of the step S4, may include a point-to-multipoint service list which the terminal 100 has subscribed and a point-to-multipoint service list which the terminal 100 is currently receiving. Also, the handover command message may transfer the MBMS service information (i.e., Information A), which the source eNB 200 provides, to the target eNB 300.

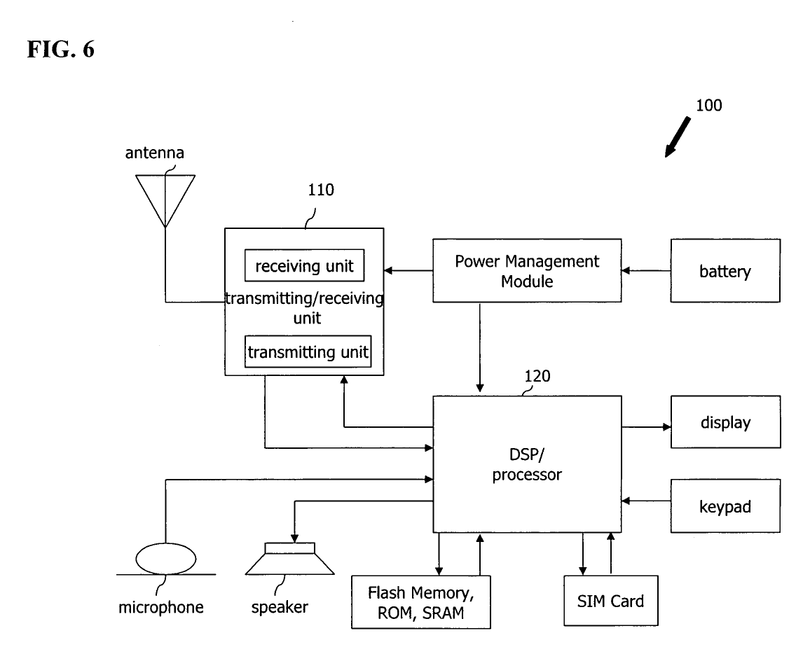

Hereinafter, configuration and functions of the terminal according to the present invention will be described with reference to FIG. 6.

FIG. 6 is a block diagram schematically showing a terminal according to the present invention.

The terminal 100 according to the present invention denotes a device which includes every device capable of using MBMS services. Hence, the terminal according to the present invention may include all types of mobile communication terminals capable of using MBMS services (e.g., mobile phones, cellular phones, DMB phone, camera phones and the like), other electronics capable of using such MBMS services (e.g., game players, notebooks, desktop computers, home electronics and the like).

The terminal 100 according to the present invention may be configured by including essential hardware for implementing technical features of the present invention, software and a module (device) including the software. Hereinafter, the configuration and functions of the terminal 100 according to the present invention will be described.

For example, the terminal 100 of the present invention may include a transmitting/receiving unit 110 having a receiving unit for receiving the handover command message from the source eNB 200, and a transmitting unit for transmitting the point-to-multipoint service information included in the handover command message to the target eNB 300 according to the indication (e.g., possibly a type of indicator or parameter) to transfer the point-to-multipoint service information, and a processor 120 for analyzing the handover command message to check whether the message includes the indication (command) for the transfer of the point-to-multipoint service information, and processing the point-to-multipoint service information to be transmitted to the target eNB 300 if the indication is included. Here, the point-to-multipoint service information is the same as described in FIG. 5. That is, the point-to-multipoint service information may include at least one of the terminal related MBMS service information (i.e., Information B) and the MBMS service information (i.e., Information A) provided by the source eNB 200. Also, the terminal related MBMS service information (i.e., Information B) may include the point-to-multipoint service list which the terminal 100 has subscribed and the point-to-multipoint service list which the terminal 100 is currently receiving.

In addition, the terminal 100 according to the present invention may include a display and a speaker as output devices, a keypad and a microphone as input devices, a battery for supplying power to the terminal 100, and basic hardware and software (or a module including the software) (e.g., a storage medium (e.g., a memory) for storing a mobility protocol list supportable by the terminal. The description of each function of such components will be obvious to those skilled in the art, and will thusly be omitted.

Meanwhile, the method according to the present invention, as described so far, can be implemented by hardware or software, or any combination thereof. For example, the method according to the present invention may be stored in a storage medium (e.g., an internal memory of a mobile terminal, a flash memory, a hard disc, etc.). Alternatively, the method according to the present invention can be implemented as codes or command words within a software program capable of being executed by a processor (e.g., a microprocessor in a mobile terminal).

### EFFECT OF THE INVENTION

When a terminal having subscribed a point-to-multipoint service moves from a first base station to a second base station, the terminal is commanded (indicated) by the first base station to transfer point-to-multipoint service information, and then transfers to the second base station a point-to-multipoint service list the terminal has subscribed or information on the point-to-multipoint service received from the first base station, whereby a service delay which may occur during the handover can be effectively avoided.

As described above, the foregoing embodiments have been illustrated with reference to the drawings but they are merely exemplary. Thus, many alternatives, modifications, and variations will be apparent to those skilled in the art. For example, a mobile communications system including the configuration as shown in FIG. 5 can be embodied, and also each component in FIG. 5 can implement the present invention via a processor and a module for processing each signal. Therefore, all changes and modifications that fall within the metes and bounds of the claims, or equivalents of such metes and bounds are therefore intended to be embraced by the appended claims.

What is claimed is:

1. A method of performing a handover in a mobile communications system, the method comprising:
determining a handover, by a first base station, and transmitting to a second base station a handover request message including first information related to a point-to-multipoint service;
receiving, by the first base station, a response message from the second base station; and
indicating, by the first base station, the terminal to transfer the first information to the second base station via a handover command message, when the first base station does not receive second information related to the point-to-multipoint service from the second base station via the response message.

2. The method of claim 1, further comprising:
synchronizing, by the terminal, a downlink channel with the second base station;
transmitting, by the terminal, a random access preamble to the second base station;
receiving a random access response in the terminal; and
transmitting, by the terminal, a handover confirm message to the second base station.

3. The method of claim 1, wherein the first information related to the point-to-multipoint service comprises at least one of:
point-to-multipoint service information which the first base station provides; and
point-to-multipoint service information related to the terminal.

4. The method of claim 3, wherein the point-to-multipoint service information provided by the first base station is control information of the first base station with respect to a point-to-multipoint service which the terminal has subscribed and/or a point-to-multipoint service which the terminal is currently receiving.

5. The method of claim 3, wherein the point-to-multipoint service information related to the terminal includes a point-to-multipoint service list which the terminal has subscribed and a point-to-multipoint service list which the terminal is currently receiving.

6. The method of claim 4, wherein the control information includes a transmission rate of MTCH (MBMS Traffic Channel), a transmission period of MCCH (MBMS Control Channel), MTCH scheduling information, and HARQ (Hybrid Auto Repeat reQuest) information including the number of retransmissions.

7. The method of claim 1, wherein the second information related to the point-to-multipoint service includes control information of the second base station with respect to the point-to-multipoint service which the terminal has subscribed and/or the point-to-multipoint service which the terminal is currently receiving.

8. The method of claim 7, wherein the control information of the second base station includes MCCH configuration information, a MCCH transmission period, MTCH configuration information, MTCH scheduling information, HARQ information on MTCH, and information on an uplink feedback channel for MBMS.

9. The method of claim 7, wherein the control information of the second base station includes a random access preamble signature for the point-to-multipoint service used in the second base station.

10. A method of performing a handover in a mobile communications system, the method comprising:
receiving, by a first base station, from a second base station a response message in response to a handover requested to the second base station; and
transmitting, by the first base station, a handover command message to the terminal, so as to indicate the terminal to transfer to the second base station information related to a point-to-multipoint service.

11. The method of claim 10, wherein the information related to the point-to-multipoint service includes at least one of:
point-to-multipoint service information provided by the first base station; and
point-to-multipoint service information related to the terminal.

12. A terminal comprising:
a transmitting/receiving unit including a receiving unit adapted to receive a handover command message from a source base station, and a transmitting unit adapted to transmit to a target base station point-to-multipoint service information included in the handover command message according to an indication to transfer the point-to-multipoint service information; and
a processor adapted to process the point-to-multipoint service information to be transmitted to the target base station when the indication to transfer the point-to-multipoint service information is included in the handover command message.

13. The terminal of claim 12, wherein the handover command message further includes point-to-multipoint service information provided by the source base station.

14. The terminal of claim 12, wherein the point-to-multipoint service information is point-to-multipoint service information related to the terminal.

15. The terminal of claim 13, wherein the point-to-multipoint service information is not only point-to-multipoint service information provided by the source base station but also point-to-multipoint service information related to the terminal.

16. The terminal of claim 12, wherein the point-to-multipoint service information is transmitted by being included in a handover confirm message.
